(19) United States
(12) Patent Application Publication
(10) Pub. No.: US 2010/0231814 A1
(43) Pub. Date: Sep. 16, 2010

(54) Liquid crystal display device and its driving method

(76) Inventors: Naoshi Yamada, Mie (JP); Toshihide Tsubata, Mie (JP)

Correspondence Address: HARNESS, DICKEY & PIERCE, P.L.C., P.O. BOX 8910, RESTON, VA, 20195, US

(21) Appl. No.: 12/308,510

(22) PCT Filed: Apr. 23, 2007
(86) PCT No.: PCT/JP2007/058744

§ 371 Date: Dec. 17, 2008

(30) Foreign Application Priority Data
Sep. 6, 2006 (JP) 2006-241077

(51) Int. Cl. G06F 3/038; G09G 3/36; H04N 3/14

(52) U.S. Cl. 348/792; 345/98; 345/212; 348/E03.001

(57) ABSTRACT

An object of the present invention is to provide a liquid crystal display device which is capable of preventing single-image prolonged-display screen burn while keeping an image constantly on display.

The liquid crystal display device includes a liquid crystal panel provided with groups of pixel formation portions disposed in a matrix pattern, and a backlight which is capable of turning ON/OFF of lighting for each region which includes a predetermined number of scanning lines. Each frame period for an entered video signal is divided into a first sub-frame period and a second sub-frame period. In the first sub-frame period, the liquid crystal panel is supplied with a data signal based on the entered video signal as the scanning lines are selected. In the second sub-frame period a data signal based on a refresh data for prevention of screen burn is supplied. Each region as a unit of backlight ON/OFF state control is supplied with lighting when pixel formation portion group on the scanning lines served by the region are supplied with data signal based on the entered video signal while lighting is not supplied when data signal based on the refresh data is supplied.

### TECHNICAL FIELD

The present invention relates to liquid crystal display devices, and more specifically to a technique for preventing screen burn caused by displaying the same image for a long time on a liquid crystal display device.

### BACKGROUND ART

In the field of liquid crystal display device, TFT (Thin Film Transistor) active matrix method is used widely. FIG. 16 is an exploded perspective view showing a configuration of a liquid crystal panel in a typical TFT liquid crystal display device in a schematic manner, featuring an area which represents four pixels. Liquid crystal panels usually include: an active matrix substrate (hereinafter called “TFT substrate”) 2 provided with a matrix of pixel circuits composed of TFTs serving as switching devices, pixel electrodes, and other constituent structures; an opposed substrate 3 provided by an insulating, transparent substrate made of glass, for example, and having a surface formed entirely with a layer of opposed electrodes and then with a layer of an alignment film; a liquid crystal layer sandwiched between these two substrates; and a polarity plate provided on an outer surface in each of the two substrates. More specifically, a liquid crystal 1 is sealed between pixel electrodes 8 which are formed on the TFT substrate 2 and the opposed electrodes 9 which are formed on the opposed substrate 3, via alignment films (not illustrated). The TFT substrate 2 is formed with gate lines 5 for application of scanning signals, and source lines 6 for application of data signals, with a TFT 4 formed near each intersection made by the gate lines 5 and the source lines 6. By turning ON/OFF the TFTs 4, the pixel electrodes 8 are supplied with electric charge which controls an electric field applied to the liquid crystal, thereby changing the crystal's optical characteristic so that the liquid crystal panel can be used as a set of optical shutters. CS lines 7 are a wiring for storage capacitors which assist holding of the voltage applied to the liquid crystal.

With the above-described configuration of the liquid crystal panel, there is implemented a pixel array where a multiple number of pixel formation portions are disposed in a matrix pattern, with each pixel formation portion corresponding to one of the intersections made by the gate lines 5 and the source lines 6. FIG. 17 shows an equivalent circuit of a pixel formation portion P(i, j) which corresponds to an intersection made by the i-th source line Xi and the j-th gate line Yj. The pixel formation portion P(i, j) includes a TFT 4 provided near the intersection and a pixel electrode 8. The TFT 4 has its gate terminal connected to a gate line Yj which passes the intersection, its source terminal connected to the source line Xi which passes the intersection, and its drain terminal connected to the pixel electrode 8. Additionally, the pixel formation portion P(i, j) further includes a pixel capacitor Cpix formed by the pixel electrode 8, an opposed electrode 9 and a liquid crystal sandwiched therebetween, as well as an auxiliary capacitor Ccs formed by the pixel electrode 8 and a CS line 7. Further, there is a parasitic capacitor Cgd between the pixel electrode 8 and the gate line 5.

The liquid crystal display device as described above is capable of displaying desirable images by controlling the voltage between each pixel electrode 8 and the opposed electrode 9 and thereby changing the optical characteristic of the liquid crystal in each pixel formation portion.

Now, liquid crystal display devices have a problem of so called “screen burn,” a phenomenon that an image which has been displayed on the screen for a long time persists on the screen even after a different image is displayed. For example, assume a case in FIG. 20 where a black square is displayed for a long time on a white background, and then solid gray is displayed over the entire screen. In this case, the square is sometimes recognized as illustrated in FIG. 21 on the location where it was displayed, or a square frame or part of the sides of the square is recognized as shown in FIG. 22 despite the fact that there is no such patterns entered as display signal input.

A cause of this problem is a residual charge in the liquid crystal panel. Specifically, if the voltage applied to the liquid crystal contains a direct current (DC) component, a charge which is called residual DC will remain in the alignment film and so on even after the voltage application is stopped, and this affects the display operation, resulting in screen burn (hereinafter, this burn will be referred to as “residual-charge screen burn”). A solution which is already public to this problem is to periodically reverse the polarity of data signal supplied to the liquid crystal panel, thereby implementing AC voltage application to the liquid crystal. Specifically, this is a proposal for AC driving of liquid crystal panels. For example, Japanese Patent Laid-Open No. Sho 59-119328 Gazette (Patent Document 1) discloses a method for AC application to TFT liquid-crystal display devices.

The disclosed method will now be described with reference to FIG. 17 and FIG. 18. When a voltage which is applied to the gate line Yj of the liquid crystal panel (hereinafter called “scanning voltage”) V_{G} attains a value to turn on the TFT 4 (hereinafter called “ON-voltage value”), a voltage which is applied as a data signal to the source line Xi (hereinafter called “data signal voltage”) V_{D} is supplied to the pixel electrode 8 via the TFT 4. In this example, the AC driving is implemented by reversing the polarity of data signal voltage. V_{D} for each frame period. However, when the scanning voltage V_{G} reaches a value to turn off the TFT 4 (hereinafter called “OFF-voltage value”), the change in the scanning voltage V_{G} from the ON-voltage value to the OFF-voltage value affects the electric potential of the pixel electrode 8 (hereinafter called “pixel potential”) V_{S} via the parasite capacitor Cgd, causing a drop in the pixel potential V_{S} by what is termed as push-down voltage or by an amount of voltage ΔV_{S}. Even when the polarity of data signal voltage V_{D} is reversed, the pixel potential V_{S} drops by this amount or by the push-down voltage ΔVs. Thus, in the liquid crystal panel drive method according to the Japanese Patent Laid-Open No. Sho 59-119328 Gazette (Patent Document 1), a correction is made to the scanning voltage V_{C} (or the pixel potential V_{S}) by a corresponding amount to ΔV_{S} so that the positive-polarity phase and the negative-polarity phase will be substantially symmetrical with each other as shown in (V_{S}-V_{C}) in FIG. 18; and thereby DC component is further removed.

However, with this drive method which is disclosed in Japanese Patent Laid-Open No. Sho 59-119328 Gazette (Patent Document 1), there is still a problem of screen burn due to such a cause as various ionic impurities in the liquid crystal which move at different speeds under voltage application and eventually result in uneven distribution within the liquid crystal if the same image is displayed for a long time. (Hereinafter, this screen burn will be called “single-image prolonged-display screen burn”). As a solution to this problem, Japanese Patent Laid-Open No. 2004-325853 Gazette (Patent Document 2) discloses a method where, during a period of prolonged display of an image without changes, a tone reversal operation is made to the image and the tone-reversed image is displayed thereby reversing the moving direction of the ionic impurities and preventing a long-term screen burn.

According to the first embodiment disclosed in Japanese Patent Laid-Open No. 2004-325853 Gazette (Patent Document. 2), as shown in a flowchart in FIG. 19, a determination is made as to whether or not the liquid crystal monitor is supplied with both of the horizontal and vertical synchronization signals (S100). If a result of the determination is that both of the horizontal and vertical synchronization signals are entered, image signals are outputted to the liquid crystal monitor (to the liquid crystal module therein) (S102). If a result of the determination is that either one of the horizontal and vertical synchronization signals is not supplied, a tone reversal operation is performed to the image signal of the latest image stored in the buffer memory to generate a signal (for a tone-reversed image of the original image which was on the display immediately before) (S104), and the reversed tone signal is outputted to the liquid crystal monitor (S106), and the backlight is turned off (S108). Thereafter, a determination is made as to whether or not both of the horizontal and vertical synchronization signals are entered (S110): If a result of the determination is that either one of the horizontal and vertical synchronization signals is not entered, the system continues to output the reversed tone signals to liquid crystal monitor (S106) and the backlight is kept unlit (S108). If a result of the determination is that both of the horizontal and vertical synchronization signals are entered, a normal image signal is outputted to the liquid crystal monitor (S112), and the backlight is brought back to the original brightness (S114).

As described, in the first embodiment, the system determines that there is no change in the image for a long time if there is no input for either one of the horizontal and vertical synchronization signals, upon which a tone-reversed image is outputted to move the ionic impurities in the reverse direction. This arrangement prevents long-term screen burn. Besides this, Japanese Patent Laid-Open No. 2004-325853 Gazette (Patent Document 2) discloses a method of preventing long-term screen burn by displaying solid-white or solid-black over the entire screen instead of making a tone reversal in order to dissipate the ionic impurities which became uneven in their distribution.

[Patent Document 1] Japanese Patent Laid-Open No. Sho 59-119328 Gazette

### [Patent Document 2] Japanese Patent Laid-Open No. 2004-325853 Gazette

### DISCLOSURE OF THE INVENTION

### Problems to be Solved by the Invention

The drive method according to Japanese Patent Laid-Open No. Sho 59-119328 Gazette (Patent Document 1) can prevent short-term screen burn but cannot prevent long-term screen burn. On the other hand, the method of preventing liquid crystal monitor screen burn disclosed in Japanese Patent Laid-Open No. 2004-325853 Gazette (Patent Document 2) aims at preventing single-image prolonged-display screen burn; however, the screen burn preventing operation is performed only when there is no change in the image, i.e. when either one of the horizontal and vertical synchronization signals is not entered (e.g. during a power-saving stand-by mode). For this reason, the screen burn preventing operation is performed at irregular timings, and therefore there is no consistency in terms of effectiveness. Also, turning off the backlight or displaying solid black or solid white means that there is no information displayed on the screen; in other words, the time of screen burn preventing operation is essentially an equivalent to a stand-by mode. As a result, the screen-burn preventing method disclosed in Japanese Patent Laid-Open No. 2004-325853 Gazette (Patent Document 2) has problems such as limited application.

The present invention was made in order to solve these problems, and it is an object of the present invention to provide a liquid crystal display device which is capable of preventing single-image prolonged-display screen burn while keeping an image always on display.

### Means for Solving the Problems

A first aspect of the present invention provides a liquid crystal display device for displaying an image based on an entered image signal. The display device includes:

a plurality of pixel formation portions sharing a liquid crystal layer for formation of an image by a control on an amount of light passing through the liquid crystal layer based on a voltage supplied to each of the pixel formation portions;

a drive control section for dividing each frame period as defined as a period for display of one screen of image into at least two sub-frame periods including a first and a second sub-frame periods, supplying each pixel formation portion with a pixel voltage based on the entered image signal in the first sub-frame period, and supplying each pixel formation portion with a refresh voltage based on the entered image signal in the second sub-frame period;

a lighting device for throwing light onto the pixel formation portions for transmission through the liquid crystal layer; and

a light control section for controlling turning-ON and turning-OFF of the lighting device so that those pixel formation portions supplied with the pixel voltage receive light from the lighting device while those pixel formation portions supplied with the refresh voltage do not receive light from the lighting device.

A second aspect of the present invention provides the liquid crystal display device according to the first aspect of the present invention; wherein the refresh voltage is a voltage for preventing a screen burn caused by a prolonged display of a same image based on the entered image signal.

A third aspect of the present invention provides the liquid crystal display device according to the first aspect of the present invention; the liquid crystal display device further including:

a plurality of data signal lines extending in a column direction, and

a plurality of scanning signal lines extending in a row direction across the data signal lines;

wherein the pixel formation portions are arranged in a matrix pattern to correspond to respective intersections made by the data signal lines and the scanning signal lines;

wherein the drive control section includes

a display control circuit for generating a refresh data signal for determination of the refresh voltage based on the entered image signal, outputting an image data signal representing a screen of image from the entered image signal in the first sub-frame period, and outputting the refresh data signal for a screen of image in the second sub-frame period,

a data signal line drive circuit for generating and applying to each data signal line the pixel voltage based on the image data signal in the first sub-frame period, and for generating and applying to each data signal line the refresh voltage based on the refresh data signal in the second sub-frame period, and

a scanning signal line drive circuit for applying a scanning signal to each scanning signal line so as to selectively drive the scanning signal lines in each of the first and the second sub-frame periods;

wherein each pixel formation portion is supplied with the pixel voltage or the refresh voltage via one of the data signal lines which passes a corresponding one of the intersections when one of the scanning signal lines which passes the corresponding intersection is selected;

wherein the lighting device includes a plurality of light sources each capable of turning on and turning off for a predetermined unit of lines in the matrix of the pixel formation portions; and

wherein the light control section turns on the light sources sequentially in response to the scanning signal in the first sub-frame period, and turns off the light sources sequentially in response to the scanning signal in the second sub-frame period.

A fourth aspect of the present invention provides the liquid crystal display device according to the third aspect of the present invention;

wherein each pixel formation portion includes

a switching device being turned on and off by one of the scanning signal lines which passes the corresponding intersection,

a pixel electrode connected with one of the data signal lines which passes the corresponding intersection via the switching device, and

a common electrode provided commonly for the pixel formation portions and disposed to form a predetermined capacitor between itself and the pixel electrodes; and

wherein the liquid crystal layer is sandwiched between the pixel electrodes and the common electrode.

A fifth aspect of the present invention provides the liquid crystal display device according to the first aspect of the present invention; wherein a length of the first sub-frame period is approximately equal to a length of the second sub-frame period.

A sixth aspect of the present invention provides the liquid crystal display device according to the first aspect of the present invention; wherein a first tone value indicated by the pixel voltage and a second tone value indicated by the refresh voltage supplied to each pixel formation portion in each frame period have a negative correlation with each other.

A seventh aspect of the present invention provides the liquid crystal display device according to the sixth aspect of the present invention; wherein the second tone value is equal to a difference between the first tone value and a maximum possible tone value indicative by pixel voltage based on the entered image signal.

An eighth aspect of the present invention provides the liquid crystal display device according to the first aspect of the present invention; wherein a polarity of a voltage applied to the liquid crystal layer in accordance with the pixel voltage or the refresh voltage supplied to each pixel formation portion is reversed for each frame period.

A ninth aspect of the present invention provides the liquid crystal display device according to the eighth aspect of the present invention; wherein the voltage applied to the liquid crystal layer in accordance with the pixel voltage and the voltage applied to the liquid crystal layer in accordance with the refresh voltage are of a same polarity in each pixel formation portion and in each frame period.

A tenth aspect of the present invention provides a television receiver which includes the liquid crystal display device according to the first aspect of the present invention.

An eleventh aspect of the present invention provides a drive method for a liquid crystal display device which includes a plurality of pixel formation portions sharing a liquid crystal layer for formation of an image by a control on an amount of light passing through the liquid crystal layer based on a voltage supplied to each of the pixel formation portions, for formation of an intended image by means of the pixel formation portions based on an entered image signal. The method includes:

a drive controlling step of dividing each frame period, which is a period for displaying one screen of image, into at least two sub-frame periods including a first and a second sub-frame periods, supplying each pixel formation portion with a pixel voltage based on the entered image signal in the first sub-frame period, and supplying each pixel formation portion with a refresh voltage based on the entered image signal in the second sub-frame period;

a lighting step of controlling to turn on predetermined lighting device so that those pixel formation portions supplied with the pixel voltage receive light; and

a black-out step of controlling to turn off the lighting device so that those pixel formation portions supplied with the refresh voltage do not receive light;

A twelfth aspect of the present invention provides the method according to the eleventh aspect of the present invention; wherein the refresh voltage is a voltage for preventing a screen burn caused by a prolonged display of a same image based on the entered image signal.

A thirteenth aspect of the present invention provides the method according to the eleventh aspect of the present invention; wherein a length of the first sub-frame period is approximately equal to a length of the second sub-frame period.

A fourteenth aspect of the present invention provides the method according to the eleventh aspect of the present invention; wherein a first tone value indicated by the pixel voltage and a second tone value indicated by the refresh voltage supplied to each pixel formation portion in each frame period have a negative correlation with each other.

A fifteenth aspect of the present invention provides the method according to the eleventh aspect of the present invention; wherein the second tone value is equal to a difference between the first tone value and a maximum possible tone value indicative by a pixel voltage based on the entered image signal.

### ADVANTAGES OF THE INVENTION

According to the first, second or eleventh aspect of the present invention, each pixel formation portion is supplied with a pixel voltage based on an entered image signal in the first sub-frame period whereas each pixel formation portion is supplied with a refresh voltage based on the entered image signal in the second sub-frame period, in each frame period. Also, the pixel formation portions which are supplied with a pixel voltage in the first sub-frame period receive light from the lighting device until refresh voltage is supplied in the second sub-frame period. Thereafter, however, light from the lighting device is not supplied until a pixel voltage is supplied in the first sub-frame period of the next frame period. Therefore, it is possible to prevent screen burn caused by prolonged display of the same image based on an entered image while keeping the image always on display. Further, viewers do not perceive unnecessary display made by the refresh voltage.

According to the third aspect of the present invention, a liquid crystal display device includes a plurality of pixel formation portions disposed in a matrix pattern. In each frame period, each pixel formation portion is supplied with a pixel voltage based on an entered image in the first sub-frame period upon selection by the scanning line, whereas each pixel formation portion is supplied with a refresh voltage in the second sub-frame period upon selection by the scanning line. Also, the matrix of the pixel formation portions is divided into units each consisting of a predetermined number of lines, and ON/OFF control is provided on the light sources for each unit upon selection by the scanning signal line. Thus, the pixel formation portions which are supplied with a pixel voltage in the first sub-frame period receive light from the lighting device until a refresh voltage is supplied in the second sub-frame period. Thereafter, however, light from the lighting device is not supplied until a pixel voltage is supplied in the first sub-frame period of the next frame period. The operations described above provide the same advantages as offered by the first aspect.

According to the fourth aspect of the present invention, an active matrix liquid crystal display device includes a plurality of pixel formation portions disposed in a matrix pattern. In each frame period, each pixel formation portion is supplied with a pixel voltage based on an entered image in the first sub-frame period upon selection by the scanning line, whereas each pixel formation portion is supplied with a refresh voltage in the second sub-frame period upon selection by the scanning line. Also, the matrix of the pixel formation portions is divided into units each consisting of a predetermined number of lines, and ON/OFF control is provided on the light sources of the lighting device for each unit in response to selection by the scanning signal line. With this arrangement, those pixel formation portions which are supplied with a pixel voltage in the first sub-frame period hold the pixel voltage and receive light from the lighting device until a refresh voltage is supplied in the second sub-frame period. Thereafter, however, the refresh voltage is held without lighting from the lighting device until a pixel voltage is supplied in the first sub-frame period of the next frame period. The operations described above provide the same advantages as offered by the first aspect.

According to the fifth or the thirteenth aspect of the present invention, the length of the first sub-frame period is substantially equal to the length of the second sub-frame period. This makes it possible to substantially equalize the length of period in which the liquid crystal is affected by the pixel voltage based on the entered image signal and the length of period in which the liquid crystal is affected by the refresh voltage, leading to substantially equalized moving speed of the ionic impurities in the liquid crystal and a substantially constant time average of the state of tilt of the liquid crystal molecules regardless of tone display levels. This arrangement effectively suppresses single-image prolonged-display screen burn.

According to the sixth or the fourteenth aspect of the present invention, the first tone value and the second tone value which are indicated respectively by the pixel voltage and the refresh voltage supplied to each pixel formation portion in each frame period have a negative correlation with each other. This makes it possible to supply each pixel formation portion with voltages averaging to a substantially the same tone value, and thus makes it possible to suppress single-image prolonged-display screen burn.

According to the seventh or the fifteenth aspect of the present invention, there is a tone-reversal relationship between the first tone value indicated by the pixel voltage supplied in the first sub-frame period and the second tone value indicated by the refresh voltage supplied in the second sub-frame period in each frame period. With this arrangement, each pixel formation portion is supplied with voltages averaging to the same tone value in each frame period, and thus, it is possible to suppress single-image prolonged-display screen burn effectively.

According to the eighth aspect of the present invention, the polarity of the voltage applied to the liquid crystal layer in accordance with the pixel voltage or the refresh voltage supplied to each pixel formation portion is reversed for each frame period. This means that the voltage applied to the liquid crystal does not contain direct current component, and thus it is possible to prevent screen burn caused by residual charge.

According to the ninth aspect of the present invention, the voltage applied to the liquid crystal layer in accordance with the pixel voltage and the voltage applied to the liquid crystal layer in accordance with the refresh voltage are of the same polarity in the same frame period. Thus, screen burn caused by residual charge can be prevented by reversing the polarity in each frame period.

### BRIEF DESCRIPTION OF THE DRAWINGS

FIG. 1 is a conceptual diagram for describing basic principles of the present invention.

FIG. 2 is a block diagram showing a configuration of a liquid crystal display device according to a first embodiment of the present invention.

FIG. 3 is a circuit diagram showing an electrical configuration of a pixel formation portion according to the embodiment.

FIG. 4 is a block diagram showing a configuration example of liquid crystal panel control circuit according to the embodiment.

FIG. 5 is a diagram showing a configuration of a backlight in the embodiment.

FIG. 6 is a conceptual diagram showing a positional relationship between scanning lines in a liquid crystal panel and fluorescent lamp in the embodiment.

FIG. 7 is a diagram for describing timings for scanning the liquid crystal panel and turning ON and turning OFF of the backlights in the embodiment.

FIG. 8 is a timing chart showing timings for turning ON and turning OFF of the backlights in the embodiment.

FIG. 9 consists of signal waveform charts (A) through (F) for describing a drive method for the liquid crystal display device according to the embodiment.

FIG. 10 is a diagram showing a relationship between a pixel voltage and a refresh voltage applied to the same pixel electrode in the embodiment.

FIG. 11 consists of conceptual diagrams (A) through (D) for describing a data signal flow in the embodiment.

FIG. 12 consists of diagrams (A), (B) and (C) for describing a relationship between voltages applied to the liquid crystal and states of the liquid crystal as well as states of the light source.

FIG. 13 is a block diagram showing an example configuration of a display device for a television receiver which uses a liquid crystal display device according to the present invention.

FIG. 14 is block a diagram showing an overall configuration, including a tuner portion, of the television receiver which uses the liquid crystal display device according to the present invention.

FIG. 15 is an exploded perspective view of the television receiver, showing a mechanical configuration.

FIG. 16 is an exploded perspective view showing a configuration of a liquid crystal panel in a typical TFT liquid crystal display device, in a schematic manner.

FIG. 17 is a circuit diagram showing an electrical configuration of a liquid crystal panel in a typical TFT liquid crystal display device.

FIG. 18 is a diagram for describing signal waveforms for screen burn prevention in a conventional liquid crystal display device.

FIG. 19 is a flowchart for describing a conventional solution to single-image prolonged-display screen burn in a liquid crystal display device.

FIG. 20 is a diagram showing an example of an image on display for describing single-image prolonged-display screen burn in a liquid crystal display device.

FIG. 21 is a diagram for illustrating an example of screen burn perceived when display of the image in FIG. 20 is followed by input of an image signal for display of a solid gray tone over the entire screen.

FIG. 22 is a diagram for illustrating another example of screen burn perceived when display of the image in FIG. 20 is followed by input of an image signal for display of solid gray tone over the entire screen.

### LEGEND

10 . . . Liquid crystal panel control circuit (display control circuit)
11 . . . Source driver (data signal line drive circuit)
12 . . . Gate driver (scanning signal line drive circuit)
13 . . . Liquid crystal panel
14 . . . light source control circuit
15 . . . Light source drive circuit
16 . . . Backlight
20 . . . Frame memory
100 . . . Thin-film transistor (TFT)
102 . . . Line memory
104 . . . Look-up table (LUT)
106 . . . Data selector
107 . . . Memory control section
108 . . . Timing controller
Clc . . . Pixel capacitor
Ep . . . Pixel electrode
Ec . . . Common electrode
Ls . . . Source line (data signal line)
Lg . . . Gate line (scanning signal line)
GLi . . . Scanning line (gate line, scanning signal line) (i=1, 2, . . . , N)
G(i) . . . gate signal (scanning signal) (1=1, 2, . . . , N)
S(j) . . . Data signal (j=1, 2, . . . , M)
BL1-BL8 . . . Fluorescent lamps
SW1-SW8 . . . Switches
Dv . . . Video signal (Entered image signal)
Dim . . . Image data signal
Drf . . . Refresh data signal
Vsy1-Vsy8 . . . Lamp-flashing control signal

### BEST MODE FOR CARRYING OUT THE INVENTION

### 1. Basic Principles

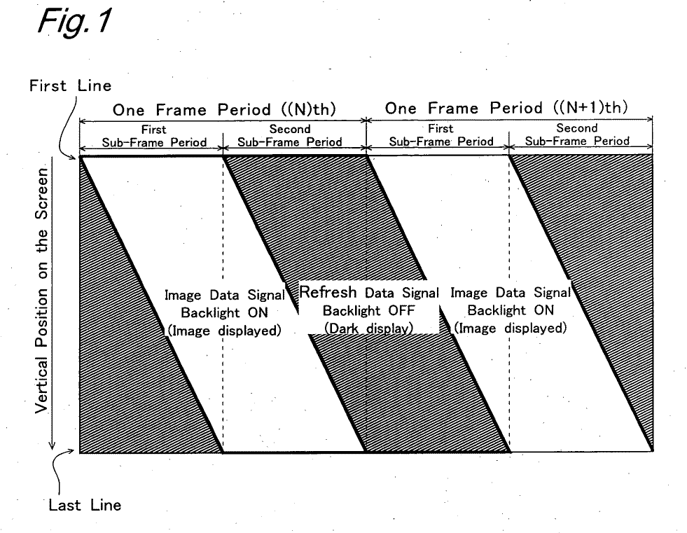

Before describing embodiments of the present invention, basic principles of the present invention will be explained with reference to FIG. 1. It should be noted here that the present invention is applicable not only to active matrix liquid crystal display devices but also passive matrix liquid crystal display devices, and the following description will be given for a case where the present invention is applied to an active matrix liquid crystal display device.

In a liquid crystal display device as an application of the present invention, a liquid crystal panel which serves as a display section includes a plurality of data signal lines, a plurality of scanning signal lines across these data signal lines, and a multiple number of pixel formation portions (hereinafter also called “pixel array”) disposed in a matrix pattern with each pixel formation portion formed correspondingly to one of the intersections made by these data signal lines and the scanning signal lines. A backlight is disposed behind the liquid crystal panel. The backlight is composed of a multiple number of linear or long light sources disposed along the scanning signal lines. For the sake of descriptive convenience, assume that it is possible to control turning ON/OFF of the backlight for each line of the pixel array as a unit area of control.

FIG. 1 shows how pixel data is written into each pixel formation portion, and how the backlight is turned ON/OFF behind each pixel formation portion (i.e. in each area corresponding to a line of the pixel array). In FIG. 1, the vertical direction (up-and-down direction) represents the vertical direction in the display screen while the horizontal direction (right-and-left direction) represents time elapsed.

Typically, the liquid crystal display device is externally supplied with a video signal for writing images to the liquid crystal panel at a frame frequency of 60 Hz. In the liquid crystal display device according to the present invention, each frame period, i.e. a period of time for making one screen of display, in the above-described video signal configuration is divided into a first sub-frame period and a second sub-frame period. Then, in the first sub-frame period, a pixel data signal based on the video signal is supplied to the liquid crystal panel (i.e. to each data signal line of the liquid crystal panel), and is written to each pixel formation portion as pixel data. In the mean time, backlights corresponding to those pixel formation portions to which the pixel data are written change their state from OFF state to ON state under control. In the second sub-frame period, a refresh data signal for preventing screen burn is supplied to the liquid crystal panel (i.e. to each data signal line of the liquid crystal panel), and is written to each pixel formation portion as refresh data. In the mean time, backlights corresponding to those pixel formation portions to which the refresh data are written change their state from ON state to OFF state under control. A reason why the backlights are turned OFF in the second sub-frame period as described is that the liquid crystal panel becomes unable to display a correct image once the refresh data is written to the pixel formation portion.

As described above, the ON/OFF state of the backlight is controlled by the unit of area which represents one line of the pixel array. As shown in FIG. 1, therefore, turning ON of the backlight in the first sub-frame period takes place for one line after another line of the pixel formation portions where pixel data writing is completed. On the other hand, in the second sub-frame period, turning OFF of the backlight takes place for one line after another line of the pixel formation portions while writing of refresh data is taking place concurrently to these unlit pixel formation portion. Specifically, in synchronization with scanning signal line selection in the liquid crystal panel, pixel data writing to each pixel formation portion and lighting of the backlight take place in the first sub-frame period whereas refresh data writing to each pixel formation portion and un-lighting of the backlight take place in the second sub-frame period. It should be noted here that in order to prevent screen burn caused by residual charge, the voltage polarity of the pixel data or refresh data to be written to each pixel formation portion is reversed in each frame period.

As described, according to the present invention, pixel formation portions which form one line of the pixel array in the screen is used as a unit in a blinking cycle, i.e., repeated alternation between the state where image display is made with the light source turned. ON and the state where dark display is made with the light source turned OFF. It is common knowledge that in the case where the frame frequency is 60 Hz, human eyes cannot perceive a display of dark state which lasts for a time shorter than one frame period. Therefore, the blinking such as the above is not recognized and the image based on the external video signal is recognized by a viewer.

According to such an arrangement as the above, it is possible to prevent screen burn caused by prolonged display of the same image while keeping an image represented by an external video signal constantly on display, by means of writing refresh data in the second sub-frame period.

### 2. Embodiments

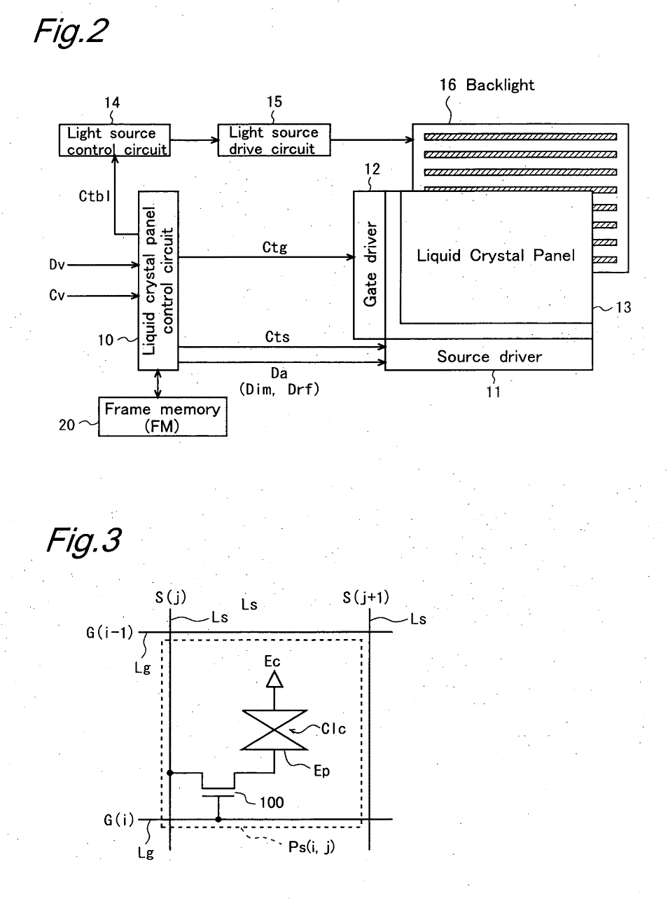

Next, an embodiment of the present invention will be described with reference to FIG. 2 through FIG. 12.

<2.1 Overall Configuration and Operation>

FIG. 2 is a block diagram which shows a configuration of a liquid crystal display device as an embodiment of the present invention. The liquid crystal display device includes an active matrix liquid crystal panel 13. The liquid crystal panel 13 is provided with a grid pattern of lines formed by a plurality (M) of source lines each extending in a Column direction and serving as a data signal line, and by a plurality (N) of gate lines each extending in a Row direction and serving as a scanning signal line. Corresponding to respective intersections formed by the source lines and the gate lines, there is a plurality (M times N) of pixel formation portions disposed in a matrix pattern, i.e. a pixel array is formed. As shown in FIG. 3, each pixel formation portion Ps(i, j) includes: a switching device provided by a thin-film transistor (hereinafter abbreviated as “TFT”) 100 which has its source terminal connected with a data signal line Ls that passes a corresponding one of the intersections and its gate terminal connected with a scanning signal line Lg that passes the corresponding intersection; a pixel electrode Ep connected with a drain terminal of the TFT 100; a common electrode Ec provided commonly for all of the pixel formation portions Ps(1, 1) through Ps(N, M); and a liquid crystal layer provided commonly for all the pixel formation portions Ps(1, 1) through Ps(N, M) and sandwiched between the pixel electrode Ep and the common electrode Ec.

The liquid crystal display device according to the present embodiment further includes: a source driver 11 as a data signal line drive circuit and a gate driver 12 as a scanning signal line drive circuit, for driving the liquid crystal panel 13; a backlight 16 as a lighting device including light sources for throwing light onto the back surface of the liquid crystal panel 13; a light source drive circuit 15 which drives the backlight 16; a light source control circuit 14 which controls the light source drive circuit 15; a frame memory 20; and a liquid crystal panel control circuit 10 as a display control circuit which output various signals to be supplied to the source driver 11, the gate driver 12, the light source control circuit 14 and the frame memory 20 in order to display an image represented by an external video signal Dv. The light source drive circuit 15 and the light source control circuit 14 constitute a light control section which provides temporal and spatial control over the lighting to the liquid crystal panel 13 performed by the backlight 16.

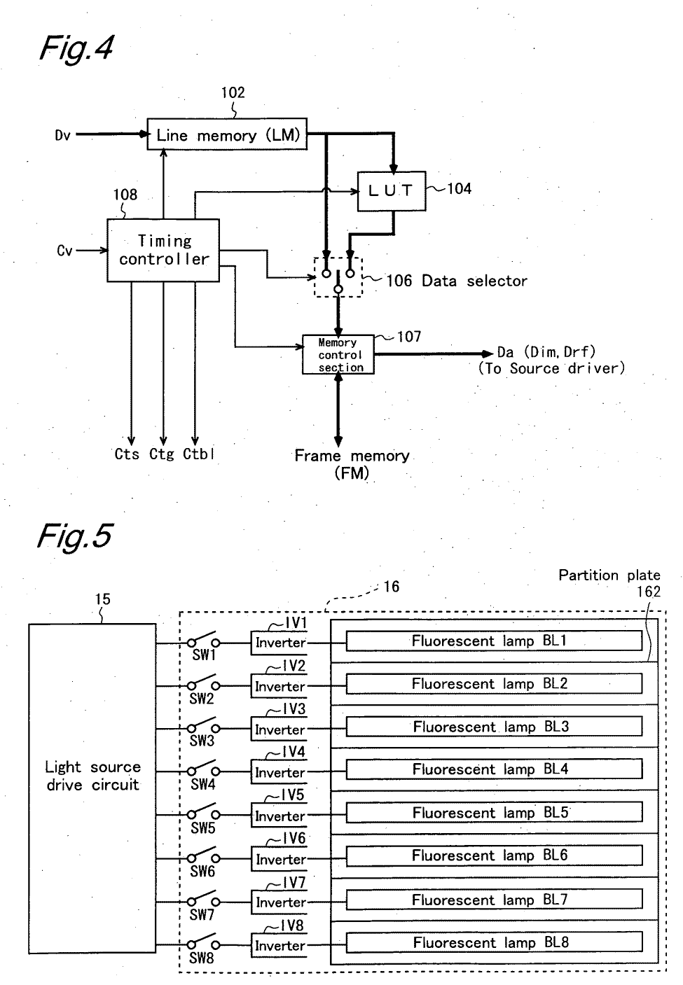

Together with the video signal Dv, the liquid crystal panel control circuit 10 receives a timing control signal Cv from outside. In the following description, the timing control signal includes a horizontal synchronization signal, a vertical synchronization signal and a clock signal associated with the video signal Dv; however, the timing control signal may be other signals as far as they provide virtually the same functions as the above-mentioned synchronizing signals and the clock signal. FIG. 4 is a block diagram which shows a configuration example of the liquid crystal panel control circuit 10. The liquid crystal panel control circuit 10 includes a line memory 102 a look-up table (hereinafter abbreviated as “LUT”) 104, a data selector 106, a memory control section 107 and a timing controller 108. The external video signal Dv is supplied to the line memory 102 while the external timing control signal Cv is supplied to the timing controller 108. It should be noted here that there may be provided a signal conversion section, as needed, for conversion of the video signal. Dv into a different signal format before being supplied to the line memory 102.

Based on the timing control signal Cv which includes the horizontal, the vertical synchronization signals and so on, the timing controller 108 generates: a control signal Cts for controlling an operation of the source driver 11; a control signal Ctg for controlling an operation of the gate driver 12; and a timing signal Ctbl for supplying to the light source control circuit 14; as well as control signals for controlling operations of the line memory 102, the memory control section 107, the LUT 104 and the data selector 106 in the liquid crystal panel control circuit 10. It should be noted here that the data read/write operations with respect to the frame memory 20 is performed by the memory control section 107 based on the control signal from the timing controller 108.

The line memory 102 has a data storage capacity for two lines of an image (hereinafter called “entered image”) represented by the video signal. Dv, and allows independent (asynchronous) writing and reading. The line memory 102 allows writing of the external video signal Dv as an image data, and reading of that image data at twice the writing speed. Specifically, while one line image data is being written, the previous one line image data is read out twice. Of these two times of reading, the first time is for an operation where the image data from the line memory 102 is written as is to the frame memory 20 via the memory control section 107, whereas the second time is for an operation where the image data from the line memory 102 is first converted into a refresh data (refresh data signal) by the LUT 104 and then written to the frame memory 20 via the memory control section 107. At this time, the data selector 106 provides switching between the image data and the refresh data, to select the data to be written to the frame memory 20. The LUT 104 functions as a refresh data generation section which generates refresh data from the image data for screen burn prevention. As will be described later, the first sub-frame period uses image data as a basis for generation of a pixel voltage which is to be supplied to each of the pixel electrodes in the liquid crystal panel 13 whereas the second sub-frame period uses refresh data generated from the image data, as a basis for generation of a refresh voltage which is to be supplied to each of the pixel electrodes in the liquid crystal panel 13. It should be noted here that the LUT 104 may be replaced by an arithmetic circuit which generates refresh data from image data for screen burn prevention.

Now, while image data for one line of the entered image is being written to the line memory 102 as described above, the memory control section 107 makes writing to the frame memory 20, transferring the previous one-line image data which was written to the line memory 102 immediately before and the corresponding one-line refresh data. In association with the above-described writing to the frame memory 20, the memory control section 107 performs reading from the frame memory 20 at the same speed as it writes (i.e. at twice the writing speed to the line memory 102). With this operation, in the first sub-frame period, one frame of image data is sequentially read out and outputted as image data signal Dim whereas in the second sub-frame period, one frame of refresh image data which corresponds to the image data that was read out immediately before is sequentially read out and outputted as refresh data signal Drf. In this way, the liquid crystal panel control circuit 10 makes alternating output of the image data signal Dim and the refresh data signal Drf, and these signals. Dim, Drf are supplied to the source driver 11 as a driver data signal Da.

Based on the driver data signal Da and the control signal Cts as described, the source driver 11 makes alternating application of a data signal based on the image data signal Dim and a data signal based on the refresh data signal Drf as a drive data signal (hereinafter simply called “data signal”) to the source line in the liquid crystal panel. More specifically, the source driver 11 generates a pixel voltage based on the image data signal Dim and applies this signal as the data signal to each source line in the first sub-frame period while generating a refresh voltage based on the refresh data signal Drf and applies this signal as the data signal to each source line in the second sub-frame period. On the other hand, the gate driver 12 generates a gate signal based on the control signal Ctg and applies this signal to each gate line for sequential selection of the N gate lines in the liquid crystal panel 13 in each of the first and the second sub-frame periods in each frame period. Also, the common electrode Ec is supplied with a predetermined common potential Vcom from an unillustrated common electrode drive circuit.

As understood from FIG. 3, upon selection of each pixel formation portion Ps(i, j), i.e. upon selection of a corresponding gate line Lg, or more specifically when the gate signal G(i) becomes active, the TFT 100 within the selected pixel formation portion is turned ON. As a result, an electric potential of the data signal S(j) in the corresponding source line Ls is supplied through the TFT 100 to the pixel electrode Ep, and the pixel capacitor Clc of this pixel formation portion Ps(i, j) is charged to a voltage represented by the data signal S(j). This means that pixel data or refresh data represented by the data signal S(j) has been written to the pixel formation portion Ps. Thereafter, when the gate line Lg is deselected, i.e. when the gate signal G(i) becomes inactive, the TFT 100 is turned OFF and the charged voltage in the pixel capacitor Clc is held until this particular gate line Lg is selected again.

The light source control circuit 14 turns ON or OFF the light sources in the backlight 16 by controlling the light source drive circuit 15 based on the timing control signal Ctbl from the liquid crystal panel control circuit 10.

In the present embodiment, each frame period is divided into the first sub-frame period and the second sub-frame period based on the basic principle (see FIG. 1) described earlier. In the first sub-frame period, a data signal S(j) based on the image data signal Dim is written to each pixel formation portion Ps(i, j) as pixel data, and this pixel data is held for a length of time equal to a half of one frame period. During this time, a fluorescent lamp in the backlight 16 which corresponds to this pixel formation portion Ps(i, j) is turned ON. On the other hand, in the second sub-frame period, a data signal S(j) based on the refresh data signal Drf is written to each pixel formation portion Ps(i, j) as refresh data, and this refresh data is held for a length of time equal to a half of one frame period. During this time, the fluorescent lamp in the backlight 16 which corresponds to this pixel formation portion Ps(i, j) is turned OFF. With this arrangement, data signal which is not necessary for intended display is non-perceivable, and thus the viewer perceives an image based on the external video signal Dv (image data signal Dim). Details of these operations will be described later.

<2.2 Backlight Configuration and Operation>

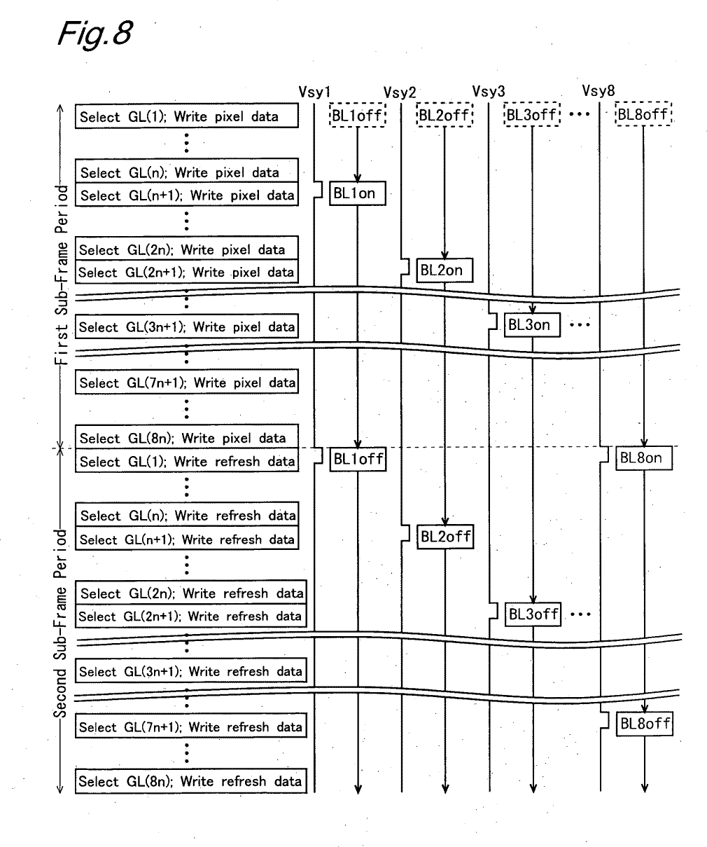

FIG. 5 shows a configuration of the backlight 16 in the present embodiment. The backlight 16 includes a plurality (eight in the example shown in FIG. 8) of direct fluorescent lamps BL1 through BL8 arranged on the back surface, of the liquid crystal panel 13 in parallel to the gate lines Lg, inverters IV1 through IV8 and switches SW1 through SW8 each corresponding to one of these fluorescent lamps BL1 through BL8. Each fluorescent lamp BLi is connected with the light source drive circuit 15 via its corresponding inverter IVi and switch SWi. Thus, these fluorescent lamps BL1 through BL8 are capable of being turned ON and OFF independently from each other, with each of the lamps corresponding to one of eight vertically divided regions of the liquid crystal panel 13 (the pixel array is divided into eight regions in the Column direction) (hereinafter, each of the divided regions will be called “block”). Also, in order to prevent decrease in display quality caused by light from each of the fluorescent lamps BLi(i=1 through 8) leaking to other blocks than the intended block, a partition plate 162 is provided between any mutually adjacent fluorescent lamps BLj and BLj+1(j=1, 2, . . . , 7). Thus, each fluorescent lamp irradiates only those pixel formation portions in the corresponding block when turned ON. These fluorescent lamps BL1 through BL8 may be provided by cold-cathode tubes.

The present embodiment uses eight fluorescent lamps: If the number of fluorescent lamps is increased, the number of gate lines Lg covered by one fluorescent lamp decreases, which will decrease luminance non-uniformity caused by signal application time difference from one gate line Lg to another in the application of pixel data to pixel electrodes Ep in the pixel formation portion. However, an increase in the number of fluorescent lamps requires an increase in the number of inverters and switches, resulting in increased cost and power consumption. On the other hand, if the number of fluorescent lamps is decreased, there will be a case where a desired level of display luminance is not achievable, in which case hot-cathode tubes may be used in order to increase luminance efficiency of the fluorescent lamps. Also, the fluorescent lamps in the backlight 16 may be replaced by other light sources such as LEDs (Light Emitting Diodes), which will allow more flexibility in division of the liquid crystal panel 13 into blocks. Another alternative may be to provide an additional liquid crystal panel between a light source and the liquid crystal display panel for a function as a light shutter which allows or blocks the light from the light source thereby rendering the light source blinking capability.

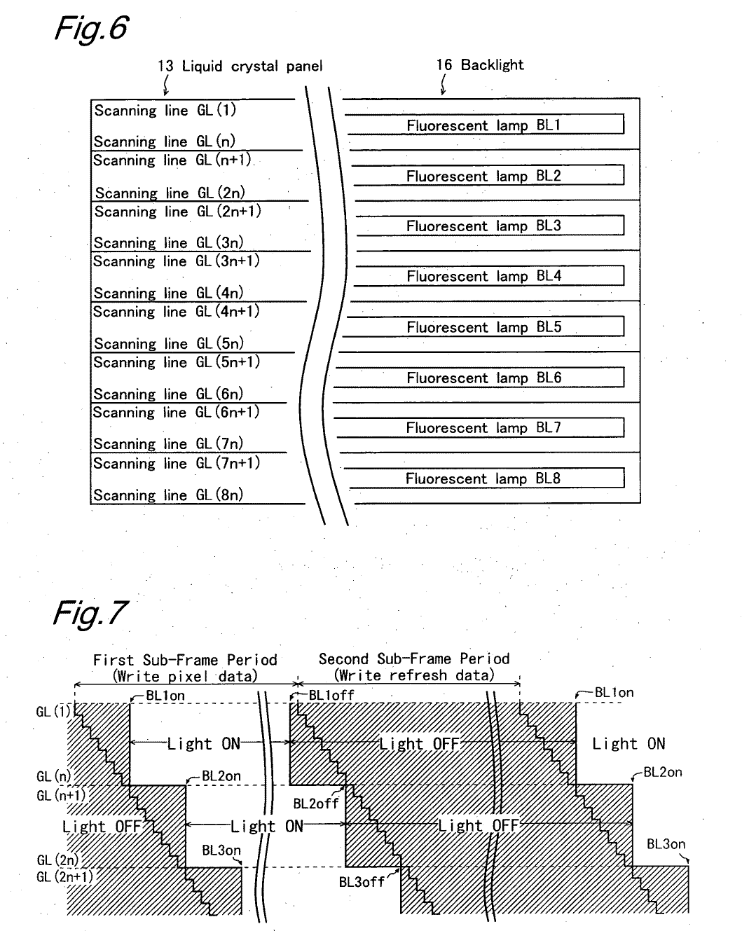

FIG. 6 shows a positional relationship between the scanning lines in the liquid crystal panel 13 and the fluorescent lamps according to the present embodiment. Note here that the scanning lines means the gate lines as the scanning signal lines, and thus the i-th scanning line, i.e., the gate line Lg to which the gate signal G(i) is applied, will be denoted as “scanning line GL(i)”. One scanning line may be regarded as a line of pixel formation portions connected thereto.

With the backlight 16 having eight fluorescent lamps, the liquid crystal panel 13 is divided into eight blocks each having as many scanning lines as a number (quotient) given by division of the number N by 8. For example, if a total number of scanning lines N=8 n, then each block will contain n scanning lines, with the fluorescent lamp BL1 serving the scanning lines GL(1) through GL(n) while the fluorescent lamp BL2 serving the scanning line GL(n+1) through GL(2n). Likewise, the fluorescent lamp BL8 serves the scanning lines GL(7n+1) through GL(8n). If the total number N of the scanning lines is indivisible by the number of fluorescent lamps in the backlight, control will be performed on the basis that those extra scanning lines are imaginary scanning lines existing outside of the scanning lines GL(1) through GL(8n). The backlight which is configured as described above is called “scanning backlight”, and disclosures are made for liquid crystal panels and scanning backlights in Japanese Patent Laid-Open No. 2000-321551 Gazette, etc.

FIG. 7 is a conceptual diagram which is related to FIG. 1, i.e., is a diagram for describing timings for scanning in the liquid crystal panel 13 and timings for turning the backlight ON and OFF according to the present embodiment. In FIG. 7, the vertical direction (up-and-down direction) represents the vertical direction in the display screen while, the horizontal direction (right-and-left direction) represents elapsed time. FIG. 8 is a timing chart which shows timings for turning ON and turning OFF of the backlight 16 (each of the fluorescent lamps therein) according to the present embodiment. The figure shows signal waveforms of lamp-flashing control signals Vsy1 through Vsy8 which are signals for ON/OFF control of the switches SW1 through SW8 assigned to the fluorescent lamps BL1 through BL8 respectively. These lamp-flashing control signals Vsy1 through Vsy8 are generated in the light source drive circuit 15 based on the timing signal Ctbl from the liquid crystal panel control circuit 10. Turning ON/OFF of each fluorescent lamp BLi (i=1, 2, . . . , 8) is controlled as the corresponding switch SWi is turned ON/OFF based on the corresponding lamp-flashing control signal Vsyi. Specifically, each fluorescent lamp BLi assumes an unlit state in its initial state (when power is applied), turns ON upon generation of a pulse serving as a lamp-flashing control signal Vsyi, and turns OFF upon generation of a next pulse serving as a lamp-flashing control signal Vsyi. Therefore, each fluorescent lamp BLi assumes the lit state and the unlit state alternately each time a pulse serving as the lamp-flashing control signal Vsyi is generated.

As shown in FIG. 8, in the first sub-frame period, each lamp-flashing control signal Vsyi assumes H level to turn ON the fluorescent lamp BLi in the corresponding block immediately after selection of the scanning lines GL((i−1)·n+1) through GL(i·n) in the block, i.e., immediately after completion of pixel data writing to the block. On the other hand, in the second sub-frame period, each lamp-flashing control signal Vsyi assumes H level to turn OFF the fluorescent lamp BLi upon or immediately before the selection of the scanning lines GL((i−1)·n+1) through GL(i·n) in the corresponding block, i.e., upon or immediately before starting of refresh data writing to the block.

Therefore, with the fluorescent lamp BLi serving the “i-th block” (i=1, 2, . . . , 8), a scenario in the first sub-frame period is as follows: During sequential selection of the scanning lines GL(1) through GL(n) contained in the first block, all of the fluorescent lamps BL1 through BL8 assume an unlit state; upon starting selection of the first scanning line GL(n+1) in the second block, the fluorescent lamp BL1 turns. ON; then, after completing the selection of the scanning lines GL(n+1) through GL(2n) contained in the second block and upon starting selection of the first scanning line GL(2n+1) in the third block, the fluorescent lamp BL2 turns ON; and the process goes on in this way, with the fluorescent lamps BL3 through BL8 turning on sequentially. It should be noted here that the fluorescent lamp BL8 turns ON after completing the selection of the scanning line GL(7n+1) through GL(8n) contained in the eighth block and upon starting selection of the first scanning line GL(1) in the first block in the second sub-frame period.

On the other hand, in the second sub-frame period, the fluorescent lamp BL1 turns OFF upon starting selection of the first scanning line GL(1) in the first block; the fluorescent lamp BL2 turns OFF upon starting selection of the first scanning line GL(n+1) in the second block; and this process goes on in this way, with the fluorescent lamps BL3 through BL8 turning OFF sequentially.

As the sequential selection or scanning is made one time for the scanning lines GL(1) through GL(8n) in each of the first and the second sub-frame periods in each frame period as described above, the fluorescent lamps BL1 through BL8 turn ON sequentially in synchronization with the scanning in the first sub-frame period whereas in the second sub-frame period, the fluorescent lamps BL1 through BL8 turn OFF in synchronization with the scanning. In this process, the fluorescent lamp BLi in each block turns ON immediately after completion of pixel data writing to the block, and turns OFF upon (or immediately before) starting of refresh data writing to the block.

With the above-described flashing control on the fluorescent lamps BL1 through BL8, data signal which is not necessary for intended display is non-perceivable, and thus the viewer perceives an image based on the external video signal Dv (image data signal Dim). Now, as understood from FIG. 7, such a flashing control on the fluorescent lamps BL1 through BL8 results in a shorter period in which the backlight 16 (of each fluorescent lamp BLi contained therein) is turned ON than the period in which pixel data is held by the pixel formation portions in the liquid crystal panel 13. For this reason, it is preferable to increase the number of fluorescent lamps in the backlight 16, thereby reducing the number of scanning lines covered by each fluorescent lamp. Also, it is desirable that the backlight (fluorescent lamps) has as fast response speed as possible to the ON/OFF operation. Although the above-described example uses fluorescent lamps as the light sources for the backlight 16, it is more desirable to employ, for example, an LED (Light Emitting Diode) manufactured from EL (Electro Luminescence) materials for faster response speed as well as for easier division into smaller blocks which serves as the unit region in the flashing control. Such an LED may be provided by a commercially available LED lamp. Also, an organic EL (organic LED) is another candidate for the choice.

<2.3 Liquid Crystal Display Device Drive Method>

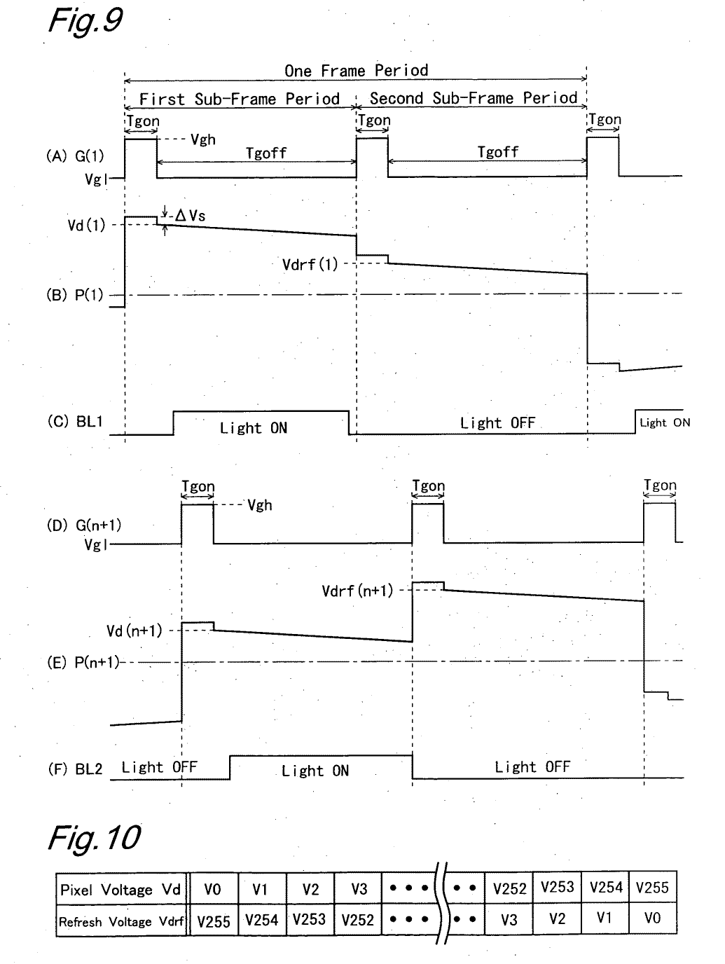

FIG. 9 is a signal waveform chart for describing a drive method for the liquid crystal display device according to the above-described embodiment. (A) of FIG. 9 shows a waveform of a gate signal G(1) applied to the first scanning line GL(1); (B) of FIG. 9 shows a waveform of an electric potential (P1) of the pixel electrode Ep in a pixel formation portion on the first scanning line GL(1); and (C) of FIG. 9 shows flashing timing of the fluorescent lamp BL1 in the first block. Also, (D) of FIG. 9 shows a waveform of the gate signal G(n+1) applied to the first scanning line in the second block, i.e., the (n+1)th scanning line GL(n+1); (E) of FIG. 9 shows a waveform of an electric potential P(n+1) of the pixel electrode Ep in a pixel formation portion on the (n+1)th scanning line GL(n+1); and (F) of FIG. 9 shows flashing timings of the fluorescent lamp BL2 in the second block. In FIG. 9, “Tgon” represents a period in which the scanning line is selected, i.e., when the gate signal is active; “Tgoff” represents a period in which the scanning line is deselected, i.e., when the gate signal is inactive; “Vgl” represents a voltage of the inactive gate signal; and “Vgh” represents a voltage of the active gate signal. Also, “ΔVs” represents a push-down voltage caused by a parasite capacitor between the pixel electrode and the gate line (scanning line); Vd(i) represents a pixel electrode potential when a pixel data is held in the pixel formation portion on the scanning line GL(i); and Vdrf(i) represents a pixel electrode potential when a refresh data is held in the pixel formation portion on the scanning line GL(i).

As shown in (A) and (D) of FIG. 9, the gate signal G(i) (i=1, 2, . . . , N) applied to a corresponding gate line Lg includes a first gate pulse for selection of the gate line Lg (scanning line GL(i)) in the first sub-frame period, and a second gate pulse for selection of the gate line Lg (scanning line GL(i)) in the second sub-frame period. As shown in (B) and (E) of FIG. 9, in the first sub-frame period, a pixel voltage Vd is applied as a data signal S(j) based on the image data signal Dim, to the pixel electrode in the pixel formation portion Ps(i, j) whereas in the second sub-frame period, a refresh voltage Vdrf is applied as a data signal S(j) based on the refresh data signal Drf, to the pixel electrode in the pixel formation portion Ps(i, j).

Now, description will be made for the refresh data signal Drf. Take a case of a pixel formation portion Ps(i, j) in the liquid crystal panel 13 where a data signal S(j) is applied to the pixel electrode contained therein. In the present embodiment, if the application of the data signal S(j) based on the image data signal Dim is of a high tone in the first sub-frame period, the following application of data signal S(j) based on the refresh data signal Drf in the second sub-frame period will be of a low tone; on the other hand, if the application of the data signal S(j) based on the image data signal Dim is of a low tone in the first sub-frame period, the following application of data signal S(j) based on the refresh data signal Drf in the second sub-frame period will be of a high tone. It should be noted here that the application of pixel voltage Vd as the data signal S(j) to the pixel electrode in the first sub-frame period represents writing of pixel data to the pixel formation portion Ps(i, j) whereas the application of refresh voltage Vdrf as the data signal S(j) to the Pixel electrode in the second sub-frame period represents writing of refresh data to the pixel formation portion Ps(i, j).

For example, if the present embodiment uses 256 tone display levels with each level taking one of tone values from 0 through 255, and if the application of data signal S(j) based on the image data signal Dim in the first sub-frame period has a tone value of n, i.e. if the applied pixel voltage Vd=Vₙ, then, the refresh voltage Vdrf which is applied immediately after (within the same frame period) should satisfy a relationship given by the following equation:

Vdrf=V₂₅₅₋ₙ (1)

In a configuration where the refresh voltage Vdrf is set as described above, a pixel voltage Vd applied to a pixel electrode in the first sub-frame period and a refresh voltage Vrf applied to the same pixel electrode in the second sub-frame within the same frame period have a relationship as shown in FIG. 10. A table which indicates the relationship in FIG. 10 may be used as the LUT 104 for generation of the refresh data signal Drf from the image data signal Dim (see FIG. 4).

It is preferable that the length of the first sub-frame period be equal to the length of the second sub-frame period. Under this arrangement, the tone voltage per frame period will have a time average of: (Vd+Vdrf)/2=Vn+V₂₅₅₋ₙ₎/2=V_{127.5}, i.e., being constant regardless of the tone given by the video signal Dv. It should be noted here that the present embodiment makes use of a scanning backlight as has been described earlier since a conventional backlight will not allow proper display of images represented by the image data signal Dim. Then, as shown in FIG. 9 (C) when the pixel voltage Vd is applied to the pixel electrode in the first sub-frame period, a corresponding fluorescent lamp in the backlight which serves a particular pixel formation portion including this pixel electrode is turned ON; and when the refresh voltage Vdrf is applied to the pixel electrode in the second sub-frame period, the corresponding fluorescent lamp in the backlight which serves this particular pixel formation portion including this pixel electrode is turned OFF.

<2.4 Data Flow>

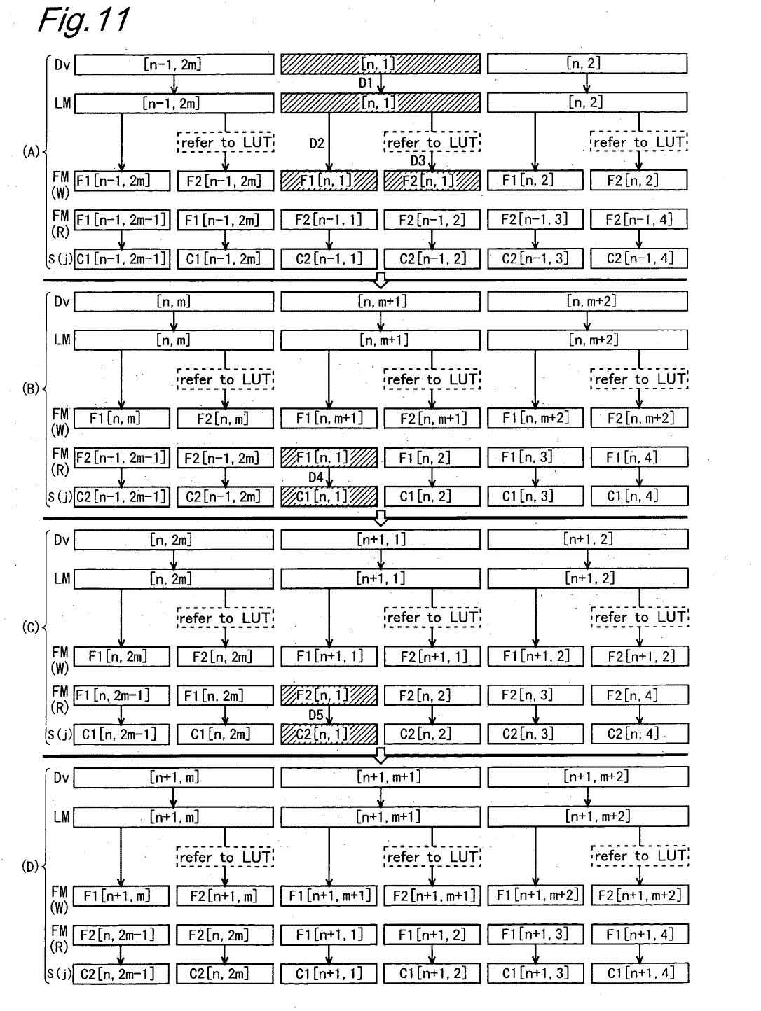

FIG. 11 is a conceptual diagram for describing a flow of data in the process of generating a refresh data signal Drf as described in the above, using an LUT. The figure shows how data (image data or refresh data) flows from the time when a video signal Dv which represents an image to be displayed is entered, to the time when a data signal is applied to the source line Ls in the liquid crystal panel 13 in each of the first and the second sub-frame periods. Note that in each of (A) through (D) of FIG. 11, time flows from upper left to upper right, and then from lower left to lower right. Note also that (B) of FIG. 11 shows data flow after a lapse of ½ frame period from the time in (A) of FIG. 11; (C) of FIG. 11 shows data flow after a lapse of ½ frame period from the time in (B) of FIG. 11; and (D) of FIG. 11 shows data flow after a lapse of ½ frame period from the time in (C) of FIG. 11. Further, note that white arrows appearing on the border from (A) through (D) of FIG. 11 indicate a lapse of time of about ½ frame period, for which no data flow chart is provided in the figure.

In FIG. 11, [n, 1] indicates data in the first line in the n-th frame while [n, m] indicates data in the middle line in the n-th frame. The term “line” utilized herein refers to a group of pixel formation portions which constitute one line in the pixel array, and one frame is constituted by 2 m lines (N=2 m).

F1[n, 1], F2[n, 1] indicate display data and refresh data for the first line in the n-th frame respectively. The display data herein is the amount of data for one line, of a set of data representing pixel voltages Vd to be applied as data signals to the respective source lines Ls in the first sub-frame period; likewise, the refresh data herein is the amount of data for one line, of a set of data representing refresh voltages Vdrf to be applied as data signals to the respective source lines Ls in the second sub-frame period. The display data F1[i, j] and the refresh data F2[i, j] are stored in different areas in the frame memory 20 (i=1, 2, . . . , n, . . . ; j=1, 2, 3, . . . , 2 m=N). Likewise, C1[n, 1], C2[n, 1] indicate display data and refresh data for the first line in the n-th frame respectively. The names “C1”, “C2” instead of “F1”, “F2” indicate that these data represent the data signals which are actually applied to the source lines Ls in the liquid crystal panel 13 in the first and the second sub-frame periods. Note also, that in FIG. 11, “LM” indicates a line memory, and “LUT” indicates a look-up table. These LM and LUT represent the line memory 102 and the LUT 104 included in the liquid crystal panel control circuit 10 respectively (FIG. 4). Also, “FM” indicates a frame memory, representing the frame memory 20 in FIG. 2. “FM(W)” indicates writing to the frame memory whereas “FM(R)” indicates reading from the frame memory.

As shown in (A) of FIG. 11, a video signal Dv which is an input from outside is first stored as display image data in the line memory (LM). Take, for example, display image data for the first line in the n-th frame: This image data is stored in the line memory (LM) at timing D1 in (A) of FIG. 11. Next, this image data is read out from the line memory (LM) and is written to the frame memory (FM) as F1[n, 1] (D2); then, the same image data is read out again from the line memory (LM), converted into a refresh data by using the LUT, and then written to the frame memory (FM) as F2[n, 1] (D3). Meanwhile, reading from the frame memory (FM) is performed sequentially for previously written refresh data F2[n−1, 1] and F2[n−1, 2], which are then supplied to the liquid crystal panel 13 as a data signal S(j) representing refresh data C2[n−1, 1] in the first half of a horizontal period of the entered video signal Dv, and also to the liquid crystal panel 13 as a data signal S(j) representing refresh data signal C2[n−1, 2] in the second half of the horizontal period. Therefore, signals which are actually supplied to the liquid crystal panel 13 have two times the frequency and a half time the horizontal period with respect to the entered video signal Dv.

Thus, the display data F1[n, 1] has been written to the frame memory (FM) at timing D2 as described above; then, as shown in (B) of FIG. 11, this data is supplied to the liquid crystal panel 13 after a ½ frame period (D4) as a data signal which represents the display data C1[n, 1]. Also, as shown in (C) of FIG. 11, the refresh data F2[n, 1] which has been written to the frame memory (FM) at timing D3 as described above is supplied to the liquid crystal panel 13 after one frame period (D5) as data signal S(j) which represents the refresh data C2[n, 1].

Hence, following the data flow as shown in (A) through (D) of FIG. 11 and based on the video signal Dv entered for each frame, the liquid crystal panel 13 (source lines Ls thereof) is supplied with the data signal S(j) which represents display data in the first half, i.e. in the first sub-frame period, of each frame period whereas the liquid crystal panel 13 (source lines Ls thereof) is supplied with the data signal S(j) which represents refresh data in the latter half, i.e. in the second sub-frame period, of each frame period. With data flow which is timed as described above and the flashing control on the scanning backlight 16 described earlier (FIG. 7 through FIG. 9), it is possible to apply the refresh voltage Vdrf to the pixel electrodes while desired images are constantly on display.

It should be noted here that though not explained in the above description about FIG. 11, the entered video signal Dv is already converted to a voltage signal which is appropriate for input to the liquid crystal panel 13. Also, gamma correction may be performed as necessary.

<2.5 Functions and Advantages>

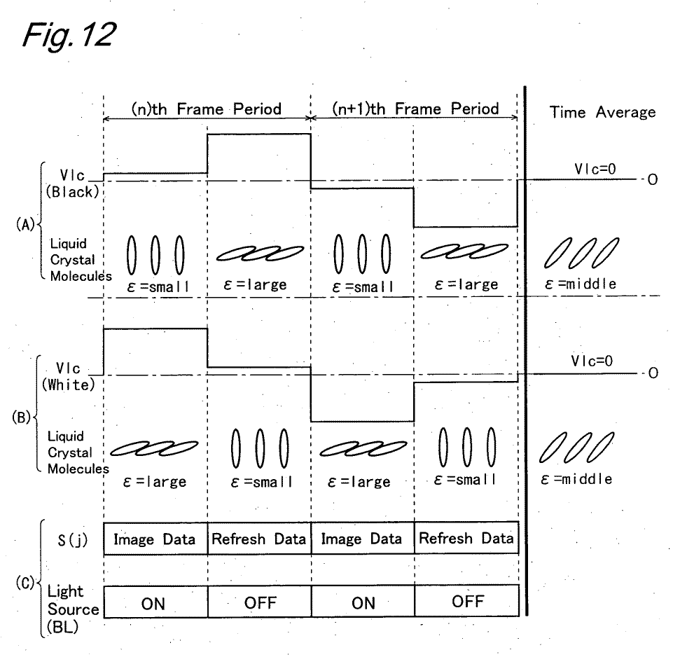

Next, functions and advantages of the present embodiment will be described with reference to FIG. 12. In FIG. 12, the horizontal direction (from left to right) represents elapsed time. Note also that the following description will be for a liquid crystal display device of a vertical alignment type which employs a normally-black mode liquid crystal of a negative dielectric anisotropy; however, the present invention is not limited to this.

(A) of FIG. 12 has an upper portion which shows a waveform of a voltage Vlc applied to the liquid crystal when displaying black, and a lower portion which shows liquid crystal molecule orientation as viewed from, a section of the liquid crystal panel 13, together with the dielectric constant ∈. (B) of FIG. 12 has an upper portion which shows a waveform of the voltage Vlc applied to the liquid crystal when displaying white, and a lower portion which shows liquid crystal molecule orientation as viewed from the section of the liquid crystal panel 13, together with the dielectric constant ∈. (C) of FIG. 12 has an upper portion indicating which, one of the image data signal Dim (display data) and the refresh data signal Drf (refresh data) was used as the basis for the voltage Vlc applied to the liquid crystal in (A) and (B) of FIG. 12, and a lower portion which shows the state of a specific light source in the backlight 16 responsible for lighting the liquid crystal area shown in (A) and (B) of FIG. 12. For the sake of descriptive convenience, assume that the liquid crystal molecules shown in (A) and (B) of FIG. 12 are those contained in pixel formation portions on the same scanning line.

Liquid crystal molecules shown in the lower portion of (A) of FIG. 12 are erected vertically by a pixel voltage Vd applied for displaying black in the first half, i.e. in the first sub-frame period, of the n-th frame period. In the latter half, i.e. in the second sub-frame period, of the n-th frame period, the liquid crystal molecules are tilted by a refresh voltage which has a value following the equation (1) listed earlier: For displaying black, the pixel voltage Vd=V₀, and the corresponding refresh voltage Vdrf=V₂₅₅. Next, in the (n+1)th frame period, the voltage polarity of the pixel electrode Ep is reversed with respect to the common electrode Ec. The liquid crystal molecules are erected vertically by a reverse-polarity pixel voltage Vd=−V₀ applied for displaying black in the first half, i.e. in the first sub-frame period, of this (n+1)th frame period. In the latter half, i.e. in the second sub-frame period, of the (n+1)th frame period, the liquid crystal molecules are tilted by a refresh voltage Vdrf=−V₂₅₅ which is a value following the equation (1) listed earlier, as a counter value for a black-displaying pixel voltage Vd=−V₀.

Liquid crystal molecules shown in the lower portion of (B) of FIG. 12 are tilted by a pixel voltage Vd=V₂₅₅ applied for displaying white in the first half, i.e. in the first sub-frame period, of the n-th frame period. In the latter half, i.e. in the second sub-frame period, of the n-th frame period, the liquid crystal molecules are erected by a refresh voltage Vdrf=V₀ applied as a counter value to the white-displaying pixel voltage Vd=V₂₅₅ which is a value following the equation (1) listed earlier. Next, in the (n+1)th frame period, the voltage polarity of the pixel electrode Ep is reversed with respect to the common electrode Ec. The liquid crystal molecules are tilted by a reverse-polarity pixel voltage Vd=−V₂₅₅ applied for displaying white in the first half, i.e. in the first sub-frame period, of this (n+1)th frame period. In the latter half, i.e. in the second sub-frame period, of the (n+1)th frame period, the liquid crystal molecules are erected by refresh voltage Vdrf=−V₀ which is a counter value for the white-displaying pixel voltage Vd=−V₂₅₅ following the equation (1).

As described, the present embodiment utilizes polarity reverse driving, and an average application voltage to the liquid crystal for two frame periods is 0V. This arrangement prevents screen burn caused by residual charge. The polarity reverse driving such as the above is disclosed in a number of public documents including Japanese Patent Laid-Open No. Sho 59-119328 Gazette (Patent Document 1), so no more details will be explained here.

As understood from comparison between (A) and (B) of FIG. 12, time average values of tilted liquid crystal molecules for two frame periods are identical with each other. Also, time average values of liquid crystal dielectric constant ∈ in the direction of voltage application for two frame periods are identical with each other. Further, with the polarity reverse driving as described above, average values of voltage applied to the liquid crystal for two frame periods are 0V for any of the liquid crystals in (A) and (B) of FIG. 12. Therefore, none of the principal factors relevant to the moving speed of ionic impurities which cause screen burn are influenced by the displayed images and hence, it is possible to reduce screen burn caused by differences in the moving speed of impurities. Ionic impurities are not the only cause of the single-image prolonged-display screen burn. One of the other causes is an unstable alignment control force in the alignment film which gives way to setting of a tilt angle memory in the alignment film by the tilted liquid crystals. However, the present invention also makes it possible to reduce screen burn caused by such because a time average of the liquid crystal molecule tilt angle for two frames is constant regardless of the tone displayed.

As has been described, according to the present embodiment, the pixel electrode in each pixel formation portion is supplied with a pixel voltage Vd based on an entered video signal Dv in the first sub-frame period of each frame period, but is supplied with a refresh voltage Vdrf which has a reversed tone value of the pixel voltage Vd in the second sub-frame period. Consequently, it is possible to prevent single-image prolonged-display screen burn while always displaying those images represented by the entered video signal Dv. Note here, that application of the refresh voltage Vd is made for each sub-frame period, which provides such advantages as constant effect of screen burn prevention, and no need for stand-by time to effect screen burn prevention. Also, the fluorescent lamps BLi in the backlight 16 which throw light to the pixel formation portions are turned OFF at the time when the refresh voltage Vdrf is applied to the relevant pixel electrodes in the pixel formation portion and then turned ON when a new pixel voltage Vd is applied to the pixel electrodes in the pixel formation portion, resulting in non-perception of unnecessary display made by the refresh voltage.

The above-described liquid crystal display device according to the present embodiment is suitable for use as a monitor in information display devices, bank ATMs (Automatic Teller Machines) and so on where a still image has to be displayed for a long time.

Differing from CRT (Cathode Ray Tube) display devices, liquid crystal display devices usually do not employ impulse-type display method. Instead, liquid crystal display devices typically employ hold-type display method in which the image is held during the frame period, and because of this an image in the previous frame is perceived as a residual image to human eyes, resulting in a perception that the displayed image has blurred edges. However, according to the control on the flashing of backlight 16 as shown in FIG. 1 and in FIG. 7, insertion of black in the display on the liquid crystal panel 13 provides an impulse-type display. Therefore, according to the present embodiment, it is possible to display high-quality images with reduced motion blurs when displaying motions pictures based on external video signals Dv.

<3. Variation>

In the embodiment described above, description was made for a case where the value of refresh voltage Vdrf is determined by the equation (1). However, the present invention requires that if the application of data signal S(j) based on the image data signal Dim is of a high tone in the first sub-frame period in each frame period, then the following application of data signal S(j) based on the refresh data signal Drf in the second sub-frame period should be of a low tone, whereas if the application of data signal S(j) based on the image data signal Dim is of a low tone in the first sub-frame period, the following application of data signal S(j) based on the refresh data signal Drf in the second sub-frame period should be of a high tone. In other words, the first tone value and the second tone value respectively represented by the pixel data and the refresh data written in each frame period must be in a negative correlation, and providing such an arrangement will offer a certain level of effectiveness in preventing single-image prolonged-display screen burn.

In the embodiment described above, the first and the second sub-frame periods are equal to each other in their length. However, even if the two periods are different in their length, similar levels of advantages are achievable as long as the difference is are not too significant.

In the embodiment described above, description was made for an active matrix liquid crystal display device. However, the present invention is also applicable to passive matrix liquid crystal display devices which do not include such a switching device as a TFT for each pixel formation portion and driving of the liquid crystal is achieved by simple crossing of scanning electrodes serving as scanning, signal lines and signal electrodes serving as data signal lines. In this case, the intersections formed by the scanning electrodes and the signal electrodes provide pixel formation portions. With this configuration, a light source in the backlight is turned ON at the time (or nearly at the time) when those pixel formation portions served by the light source are selected by selection of those scanning electrodes passing through these pixel formation portions and by application of a pixel voltage to those signal electrodes which pass these pixel formation portions, whereas the light source in the backlight is turned OFF at the time (or nearly at the time) when these pixel formation portions are selected by selection of the scanning electrodes which pass these pixel formation portions and by application of a refresh voltage to these signal electrodes which pass these pixel formation portions.

In the embodiment described above, the timing charts in FIG. 7 through FIG. 9 illustrate that the second sub-frame period in which application of the refresh signal is made is generally concurrent with the period in which the light source is turned OFF. However, depending on the response speed of the liquid crystal, a state of the liquid crystal effected by the application of refresh signal can persist during the time when the light source is turned ON and affect the displayed image. For this reason, a higher response time of the liquid crystal is preferred: Also, the time in which the light source is turned OFF may be made longer than the time in which the refresh signal is applied in the second sub-frame period.

<4. Television Receiver>

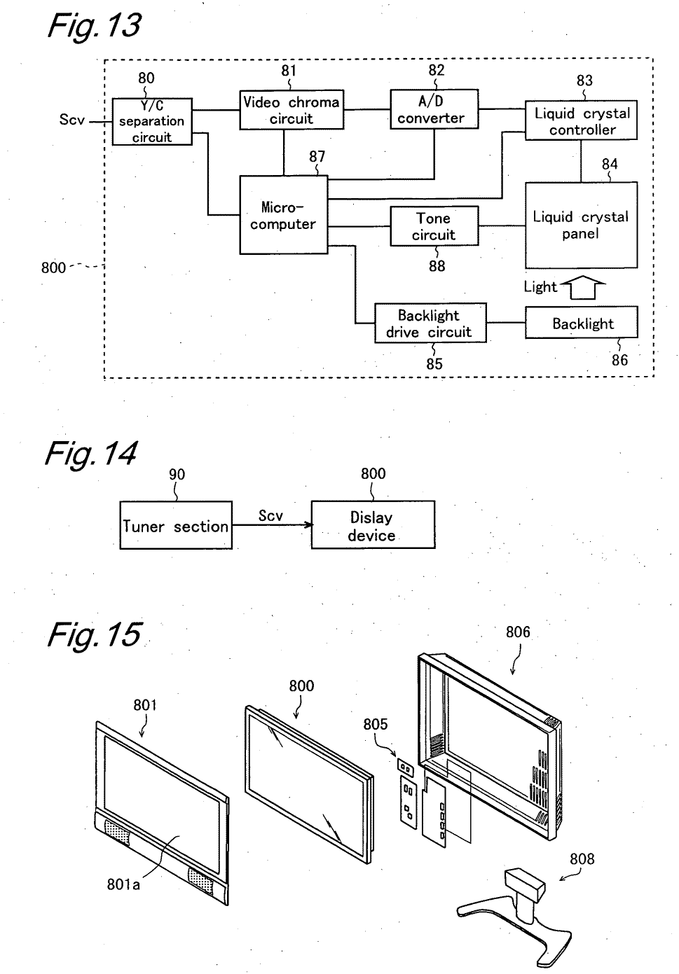

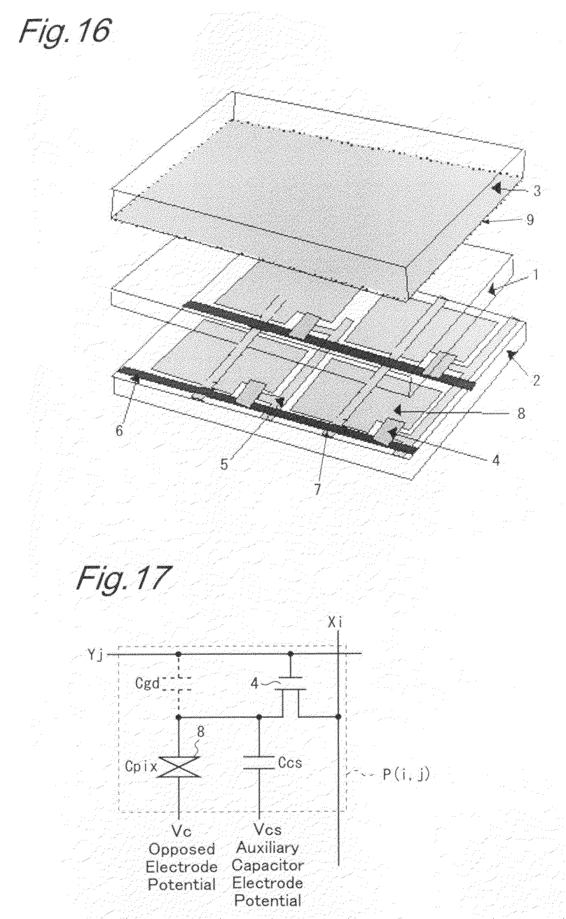

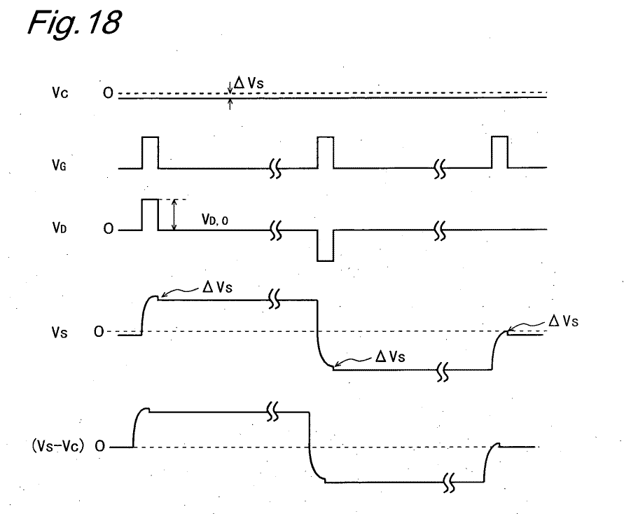

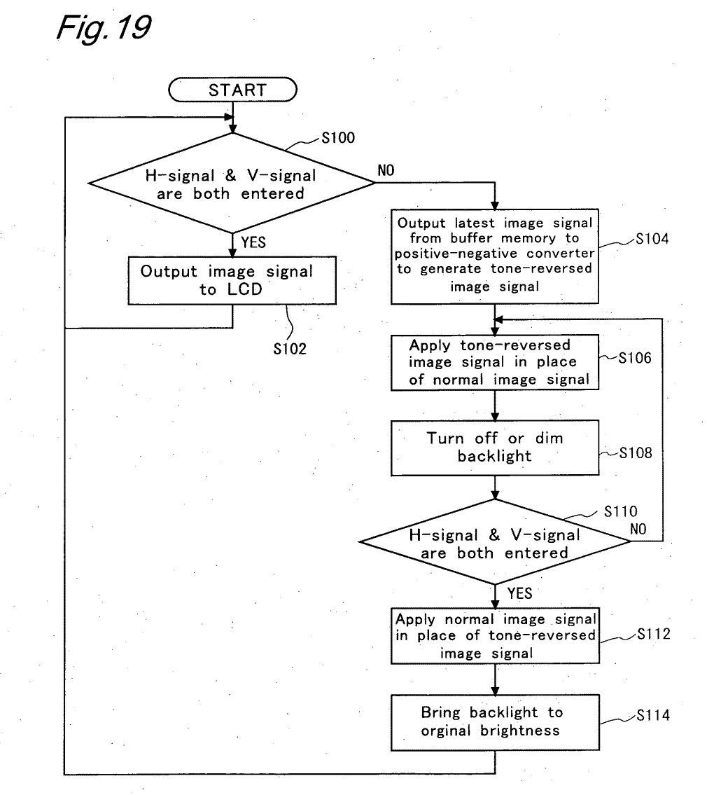

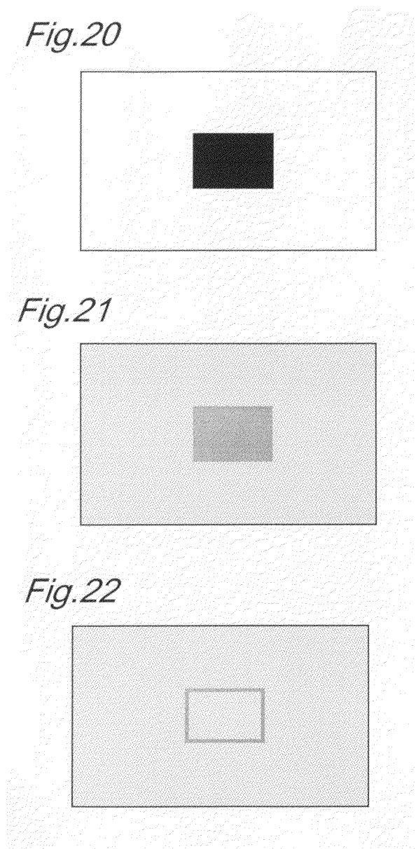

Next, description will cover an example where a liquid crystal display device according to the present invention is used in a television receiver. FIG. 13 is a block diagram which shows a configuration of a display device 800 for the television receiver. The display device 800 includes a Y/C separation circuit 80, a video chroma circuit 81, an A/D converter 82, a liquid crystal controller 83, a liquid crystal panel 84, a backlight drive circuit 85, a backlight 86, a microcomputer 87, and a tone circuit 88. The liquid crystal panel 84 includes a display section composed of an active matrix pixel array, as well as a source driver and a gate driver for driving the display section.

In the display device 800 of the above-described configuration, first, a composite color video signal Scv as a television signal is entered externally to the Y/C separation circuit 80, where the signal is separated into a luminance signal and a color signal. These luminance signal and color signal are converted by the video chroma circuit 81 into an analog RGB signal representing three primary colors of light. Further, the analog RGB signal is converted into a digital RGB signal by the A/D converter 82. The digital RGB signal is supplied to the liquid crystal controller 83. Also, the Y/C separation circuit 80 separates horizontal and vertical synchronization signals from the external input, i.e. from the composite color video signal Scv. These synchronization signals are also supplied to the liquid crystal controller 83 via the microcomputer 87.

The liquid crystal controller 83 incorporates a frame memory and an LUT (look-up table) for generation of a refresh data signal Drf, and operates similarly to the liquid crystal panel control circuit 10 in the embodiment described above, generating and outputting an image data signal Dim and a refresh data signal Drf alternately, as a driver data signal based on the digital RGB signal (an equivalent to the video signal Dv in the embodiment described above) from the A/D converter 82. Also, the liquid crystal controller 83 generates timing control signals based on the synchronization signals, in order to operate the source driver and the gate driver in the liquid crystal panel 84 substantially the same way as in the above-described embodiment, and supplies these timing control signals to the source driver and the gate driver. The tone circuit 88 generates tone voltages for each of the three primary colors or R, G, B, and these tone voltages are also supplied to the liquid crystal panel 84.

In the liquid crystal panel 84, these driver data signal, the timing control signals and tone voltages are used as a basis to generate drive signals (data signal, scanning signal, etc.) by the source driver, the gate driver and so on (FIG. 9 through FIG. 11), and color images are displayed in the incorporated display section based on these drive signals. It should be noted here that in order to display images by means of the liquid crystal panel 84, light must be cast from behind the liquid crystal panel 84. In the display device 800, the casting of light onto the back surface of the liquid crystal panel 84 is achieved by a backlight drive circuit 85 which drives a backlight 86 under the control provided by the microcomputer 87. The backlight 86 is a scanning backlight as shown in FIG. 5, like the one in the above-described embodiment. Based on control signals from the microcomputer 87 which functions also as a light source controlling section, the backlight drive circuit 85 drives the backlight 86 as shown in FIG. 7 and FIG. 8.

Overall system control including the operations described above is performed by the microcomputer 87. It should be noted here that the externally entered video signal (composite color video signal) may include not only video signals based on television broadcast but also video signals of images taken by cameras, video signals supplied via Internet connections, and so on. The display device 800 is capable of displaying images based on a variety of video signals.

When displaying images in the display device 800 based on a television broadcast, the display device 800 is connected with a tuner section 90 as shown in FIG. 14. From an incoming broadcast wave (high-frequency signal) received via an antenna (not illustrated), the tuner section 90 separates a signal from a desired channel, converts the signal into an intermediate frequency signal, subjects the intermediate frequency signal to detection, and thereby extracts a composite color video signal Scv as a television signal. The composite color video signal Scv is supplied to the display device 800 as described earlier, and images based on the composite color video signal Scv are displayed by the display device 800.

FIG. 15 is an exploded perspective view which shows an example of mechanical configuration when the above-described display device is used in a television receiver. In the example shown in FIG. 15, the television receiver includes, as its constituent elements, a first case 801 and a second case 806 in addition to the display device 800, and the display device 800 is sandwiched between the first case 801 and the second case 806 in an enclosing manner. The first the case 801 has an opening 801a for the images displayed on the display device 800 to come through. The second case 806 covers the back side of the display device 800, is provided with an operation circuit 805 for operating the display device 800, and a support member 808 on a lower side.

According to the television receiver as described above, it is possible to apply a refresh voltage Vdrf based on a refresh data signal Drf to each pixel electrode in the liquid crystal panel 84 while keeping appropriate display of images based on the composite color video signal Scv. Therefore, screen burn does not result even if the same still image is displayed for a long time due to an input of a composite color video signal Scv which represents the still image. The television display device 800 such as the above is suitable for use as a monitor in information display devices, bank ATMs (Automatic Teller Machines) and so on where a still image has to be displayed for a long time. Also, due to the control on the flashing of backlight 86 as shown in FIG. 1 and in FIG. 7, insertion of black in the display on the liquid crystal panel 84 provides an impulse-type display. Therefore, it is possible to display high-quality images with reduced motion blurs when displaying motions pictures based on composite color video signal Scv. It is also possible to reduce screen burn caused by a permanent display such as a channel number which stays all the time on the screen even when a motion picture is on the display, and to reduce other types of screen burn as well; an example is a case where the image given by the video signal has a different aspect ratio from that of the liquid crystal display device. In this case the screen has non-displayed areas on its upper and lower, or right and left portions, and a screen burn may result on the border areas.

### INDUSTRIAL APPLICABILITY

The present invention is for application to liquid crystal display devices, and is suitable particularly to liquid crystal display devices used to display a still image for a long time.

1. A liquid crystal display device for displaying an image based on an entered image signal, comprising:
a plurality of pixel formation portions sharing a liquid crystal layer for formation of an image by a control on an amount of light passing through the liquid crystal layer based on a voltage supplied to each of the pixel formation portions;
a drive control section for dividing each frame period as defined as a period for display of one screen of image into at least two sub-frame periods including a first and a second sub-frame periods, supplying each pixel formation portion with a pixel voltage based on the entered image signal in the first sub-frame period, and supplying each pixel formation portion with a refresh voltage based on the entered image signal in the second sub-frame period;
a lighting device for throwing light onto the pixel formation portions for transmission through the liquid crystal layer; and
a light control section for controlling turning-ON and turning-OFF of the lighting device so that those pixel formation portions supplied with the pixel voltage receive light from the lighting device while those pixel formation portions supplied with the refresh voltage do not receive light from the lighting device.

2. The liquid crystal display device according to claim 1, wherein the refresh voltage is a voltage for preventing a screen burn caused by a prolonged display of a same image based on the entered image signal.

3. The liquid crystal display device according to claim 1, further comprising:
a plurality of data signal lines extending in a column direction; and
a plurality of scanning signal lines extending in a row direction across the data signal lines;
wherein the pixel formation portions are arranged in a matrix pattern to correspond to respective intersections made by the data signal lines and the scanning signal lines;
the drive control section including:
a display control circuit for generating a refresh data signal for determination of the refresh voltage based on the entered image signal, outputting an image data signal representing a screen of image from the entered image signal in the first sub-frame period, and outputting the refresh data signal for a screen of image in the second sub-frame period;
a data signal line drive circuit for generating and applying to each data signal line the pixel voltage based on the image data signal in the first sub-frame period, and for generating and applying to each data signal line the refresh voltage based on the refresh data signal in the second sub-frame period; and
a scanning signal line drive circuit for applying a scanning signal to each scanning signal line so as to selectively drive the scanning signal lines in each of the first and the second sub-frame periods;
wherein each pixel formation portion is supplied with the pixel voltage or the refresh voltage via one of the data signal lines which passes a corresponding one of the intersections when one of the scanning signal lines which passes the corresponding intersection is selected,
the lighting device including a plurality of light sources each capable of turning on and turning off for a predetermined unit of lines in the matrix of the pixel formation portions,
the light control section turning on the light sources sequentially in response to the scanning signal in the first sub-frame period, and turning off the light sources sequentially in response to the scanning signal in the second sub-frame period.

4. The liquid crystal display device according to claim 3, wherein each pixel formation portion includes:
a switching device being turned on and off by one of the scanning signal lines which passes the corresponding intersection;
a pixel electrode connected with one of the data signal lines which passes the corresponding intersection via the switching device; and
a common electrode provided commonly for the pixel formation portions and disposed to form a predetermined capacitor between itself and the pixel electrodes;
the liquid crystal layer being sandwiched between the pixel electrodes and the common electrode.

5. The liquid crystal display device according to claim 1, wherein a length of the first sub-frame period is approximately equal to a length of the second sub-frame period.

6. The liquid crystal display device according to claim 1, wherein a first tone value indicated by the pixel voltage and a second tone value indicated by the refresh voltage supplied to each pixel formation portion in each frame period have a negative correlation with each other.

7. The liquid crystal display device according to claim 6, wherein the second tone value is equal to a difference between the first tone value and a maximum possible tone value indicative by a pixel voltage based on the entered image signal.

8. The liquid crystal display device according to claim 1, wherein a polarity of a voltage applied to the liquid crystal layer in accordance with the pixel voltage or the refresh voltage supplied to each pixel formation portion is reversed for each frame period.

9. The liquid crystal display device according to claim 8, wherein the voltage applied to the liquid crystal layer in accordance with the pixel voltage and the voltage applied to the liquid crystal layer in accordance with the refresh voltage are of a same polarity in each pixel formation portion and in each frame period.

10. A television receiver comprising the liquid crystal display device according to claim 1.

11. A drive method for a liquid crystal display device including a plurality of pixel formation portions sharing a liquid crystal layer for formation of an image by a control on an amount of light passing through the liquid crystal layer based on a voltage supplied to each of the pixel formation portions, for formation of an intended image by means of the pixel formation portions based on an entered image signal, the method comprising:
a drive controlling step of dividing each frame period, which is a period for displaying one screen of image, into at least two sub-frame periods including a first and a second sub-frame periods, supplying each pixel formation portion with a pixel voltage based on the entered image signal in the first sub-frame period, and supplying each pixel formation portion with a refresh voltage based on the entered image signal in the second sub-frame period;
a lighting step of controlling to turn on a predetermined lighting device so that those pixel formation portions supplied with the pixel voltage receive light; and
a black-out step of controlling to turn off the lighting device so that those pixel formation portions supplied with the refresh voltage do not receive light.

12. The drive method according to claim 11, wherein the refresh voltage is a voltage for preventing a screen burn caused by a prolonged display of a same image based on the entered image signal.

13. The drive method according to claim 11, wherein a length of the first sub-frame period is approximately equal to a length of the second sub-frame period.

14. The drive, method according to claim 11, wherein a first tone value indicated by the pixel voltage and a second tone value indicated by the refresh voltage supplied to each pixel formation portion in each frame period have a negative correlation with each other.

15. The drive method according to claim 11, wherein the second tone value is equal to a difference between the first tone value and a maximum possible tone value indicative by a pixel voltage based on the entered image signal.
